(19) United States
(12) Patent Application Publication
(10) Pub. No.: US 2026/0126679 A1
(43) Pub. Date: May 7, 2026

(54) OPTICAL SEMICONDUCTOR DEVICE

(71) Applicant: Mitsubishi Electric Corporation, Tokyo (JP)

(72) Inventors: Kyosuke KURAMOTO, Tokyo (JP); Asami UCHIYAMA, Tokyo (JP); Eitaro ISHIMURA, Tokyo (JP); Masaaki SHIMADA, Tokyo (JP)

(73) Assignee: Mitsubishi Electric Corporation, Tokyo (JP)

(21) Appl. No.: 19/278,670

(22) Filed: Jul. 23, 2025

(30) Foreign Application Priority Data
Nov. 5, 2024 (JP) 2024-193716

(51) Int. Cl. G02F 1/025

(52) U.S. Cl. CPC G02F 1/025

(57) ABSTRACT

An optical semiconductor device includes: a substrate; an optical modulator including a semiconductor layer having a first conductive type layer, an absorbing layer and a second conductive type layer which are formed in this order on the substrate, a first electrode connected to the first conductive type layer, and a second electrode connected to the second conductive type layer; a first pad connected to the first electrode; and a second pad connected to the second electrode, wherein the semiconductor layer includes a waveguide, a first terrace and a second terrace positioned on the opposite sides with respect to the waveguide, the first pad and the second pad are placed on the first terrace via an insulating film, and a groove is formed in the semiconductor layer between the first pad and the second pad.

### BACKGROUND OF THE INVENTION

### Field

The present disclosure relates to an optical semiconductor device.

### Background

An optical semiconductor device in which a laser unit and an optical modulator are monolithically integrated has been proposed (see, for example, Patent Literature 1). The optical modulator is differentially operated by the differential voltage applied between an anode pad and a cathode pad. By placing the anode pad and the cathode pad of the optical modulator on a terrace on the same side with respect to a waveguide, the lengths of wires connected to both the pads can be made equal.
Patent Literature 1: JP 5891920 B2

### SUMMARY

When the optical modulator is differentially operated, since a leakage current flows between the two pads of the optical modulator, the voltage applied to an absorbing layer of the optical modulator decreases. The leakage current flows through a capacitance under the electrodes of the optical modulator, and, therefore, as the frequency increases, the leakage current increases and the extinction ratio decreases. As a result, there is a problem of reduction of the frequency band in which the optical modulator can operate normally.

The present disclosure has been made to solve the problem mentioned above, and the purpose of the disclosure is to obtain an optical semiconductor device capable of preventing a reduction of the frequency band.

### Solution to Problem

An optical semiconductor device according to the present disclosure includes: a substrate; an optical modulator including a semiconductor layer having a first conductive type layer, an absorbing layer and a second conductive type layer which are formed in this order on the substrate, a first electrode connected to the first conductive type layer, and a second electrode connected to the second conductive type layer; a first pad connected to the first electrode; and a second pad connected to the second electrode, wherein the semiconductor layer includes a waveguide, a first terrace and a second terrace positioned on the opposite sides with respect to the waveguide, the first pad and the second pad are placed on the first terrace via an insulating film, and a groove is formed in the semiconductor layer between the first pad and the second pad.

### Advantageous Effects of Invention

In the present disclosure, the groove is formed in the semiconductor layer between the first pad and the second pad. Since this groove splits the leakage current path between them and reduces the leakage current, the response particularly in a high frequency range is improved. As a result, a reduction of the frequency band can be prevented.

### BRIEF DESCRIPTION OF DRAWINGS

FIG. 1 is a top view showing an optical semiconductor device according to a first embodiment.

FIG. 2 is a cross-sectional view of the laser unit taken along A-A′ in FIG. 1.

FIG. 3 is a cross-sectional view of the optical modulator taken along B-B′ in FIG. 1.

FIG. 4 is a cross-sectional view of the optical modulator taken along C-C′ in FIG. 1.

FIG. 5 is a cross-sectional view taken along D-D′ in FIG. 1.

FIG. 6 is a cross-sectional view taken along E-E′ in FIG. 1.

FIG. 7 is a top view showing an optical semiconductor device according to the comparative example.

FIG. 8 is a cross-sectional view taken along A-A′ in FIG. 7.

FIG. 9 is a diagram showing the frequency response characteristics of the first embodiment and the comparative example.

FIG. 10 is a top view showing an optical semiconductor device according to a second embodiment.

FIG. 11 is a cross-sectional view taken along A-A′ in FIG. 10.

FIG. 12 is a diagram showing the frequency response characteristics of the second embodiment and the comparative example.

FIG. 13 is a top view showing an optical semiconductor device according to a third embodiment.

FIG. 14 is a top view showing an optical semiconductor device according to a fourth embodiment.

FIG. 15 is a top view showing an optical semiconductor device of a first modified example according to the fourth embodiment.

FIG. 16 is a top view showing an optical semiconductor device of a second modified example according to the fourth embodiment.

FIG. 17 is a top view showing an optical semiconductor device according to a fifth embodiment.

FIG. 18 is a cross-sectional view of the first optical modulator taken along A-A′ in FIG. 17.

FIG. 19 is a cross-sectional view of the second optical modulator taken along B-B′ in FIG. 17.

FIG. 20 is a top view showing an optical semiconductor device according to a sixth embodiment.

FIG. 21 is a top view showing an optical semiconductor device according to a seventh embodiment.

FIG. 22 is a cross-sectional view showing an optical semiconductor device according to an eighth embodiment.

FIG. 23 is a top view showing an optical semiconductor device according to a ninth embodiment.

FIG. 24 is a cross-sectional view taken along A-A′ in FIG. 23.

### DESCRIPTION OF EMBODIMENTS

An optical semiconductor device according to the embodiments of the present disclosure will be described with reference to the drawings. The same components will be denoted by the same symbols, and the repeated description thereof may be omitted.

### First Embodiment

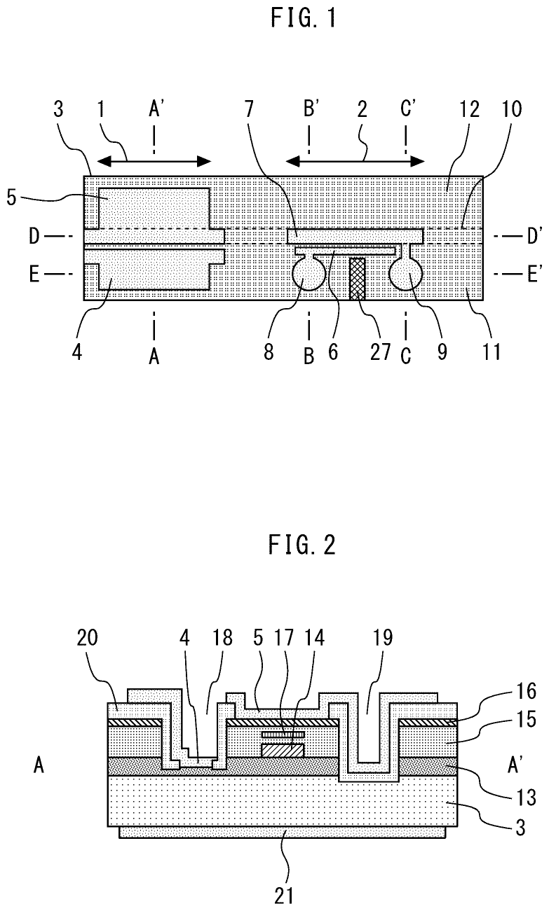

FIG. 1 is a top view showing an optical semiconductor device according to a first embodiment. This optical semiconductor device is a modulator-integrated laser diode in which a laser unit 1 and an optical modulator 2 are monolithically integrated on a semi-insulating InP substrate 3. The laser unit 1 is a distributed-feedback laser diode (DFB-LD). The optical modulator 2 is an electro-absorption modulator.

The laser unit 1 includes a cathode electrode 4 and an anode electrode 5. The optical modulator 2 includes a cathode electrode 6 and an anode electrode 7. A cathode pad 8 is connected to the cathode electrode 6. An anode pad 9 is connected to the anode electrode 7. The optical modulator 2 is differentially operated by the differential voltage applied between the cathode pad 8 and the anode pad 9.

A first terrace 11 and a second terrace 12 are positioned on opposite sides with respect to a waveguide 10. The cathode pad 8 and the anode pad 9 are placed on the first terrace 11. This makes it possible to equalize the lengths of a wire connected to the anode pad 9 and a wire connected to the cathode pad 8.

FIG. 2 is a cross-sectional view of the laser unit taken along A-A′ in FIG. 1. An n-InP cladding layer 13, an active layer 14, a p-InP cladding layer 15, and a p-InGaAs contact layer 16 are stacked in this order on the semi-insulating InP substrate 3. The active layer 14 has an InGaAsP multiple quantum well (MQW) structure.

The active layer 14 is patterned into stripes in a plan view, and both sides are embedded in an embedding layer (not shown). The embedding layer has a two-layer structure of a Fe—InP layer and an n-InP layer, or an InP-based PNP structure. A diffraction grating 17 is formed in the p-InP cladding layer 15.

On both sides of the active layer 14, grooves 18, 19 are formed in the p-InGaAs contact layer 16, the p-InP cladding layer 15, and the n-InP cladding layer 13. The upper surface of the p-InGaAs contact layer 16 and the inner surfaces of the grooves 18, 19 are covered with an insulating film 20. An opening is formed in the insulating film 20 above a mesa structure between the grooves 18, 19, and the anode electrode 5 is connected to the p-InGaAs contact layer 16 through this opening. An opening is formed in the insulating film 20 on the bottom surface of the groove 18, and the cathode electrode 4 is connected to the n-InP cladding layer 13 through this opening. An n-electrode 21 is formed on the lower surface of the semi-insulating InP substrate 3.

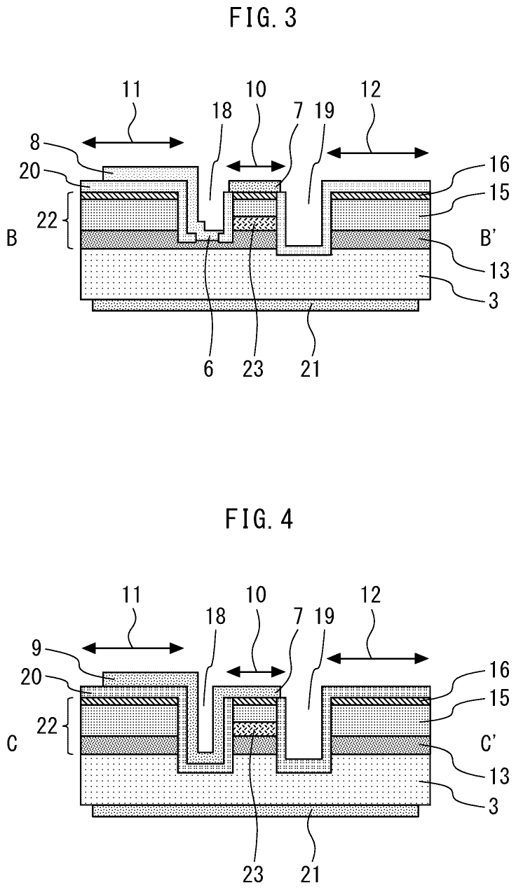

FIG. 3 is a cross-sectional view of the optical modulator taken along B-B′ in FIG. 1. As a semiconductor layer 22, the n-InP cladding layer 13, the p-InP cladding layer 15, and the p-InGaAs contact layer 16 are stacked in this order on the semi-insulating InP substrate 3. An absorbing layer 23 is stacked on the n-InP cladding layer 13 within the mesa structure between the grooves 18, 19. The absorbing layer 23 has an InGaAsP multiple quantum well structure.

The grooves 18, 19 are formed spaced apart from each other in the p-InGaAs contact layer 16, the p-InP cladding layer 15, and the n-InP cladding layer 13. The grooves 18, 19 limit the lateral width of the absorbing layer 23 to cause the absorbing layer 23 to function as the waveguide 10. The semiconductor layer 22 includes the waveguide 10, the first terrace 11 and the second terrace 12 positioned on the opposite sides with respect to the waveguide 10. An opening is formed in the insulating film 20 on the bottom surface of the groove 18, and the cathode electrode 6 is connected to the n-InP cladding layer 13 through this opening. The cathode pad 8 is placed on the first terrace 11 via the insulating film 20, and connected to the cathode electrode 6.

FIG. 4 is a cross-sectional view of the optical modulator taken along C-C′ in FIG. 1. An opening is formed in the insulating film 20 above the waveguide 10, and the anode electrode 7 is connected to the p-InGaAs contact layer 16 through this opening. Like the cathode pad 8, the anode pad 9 is placed on the first terrace 11 via the insulating film 20, and connected to the anode electrode 7.

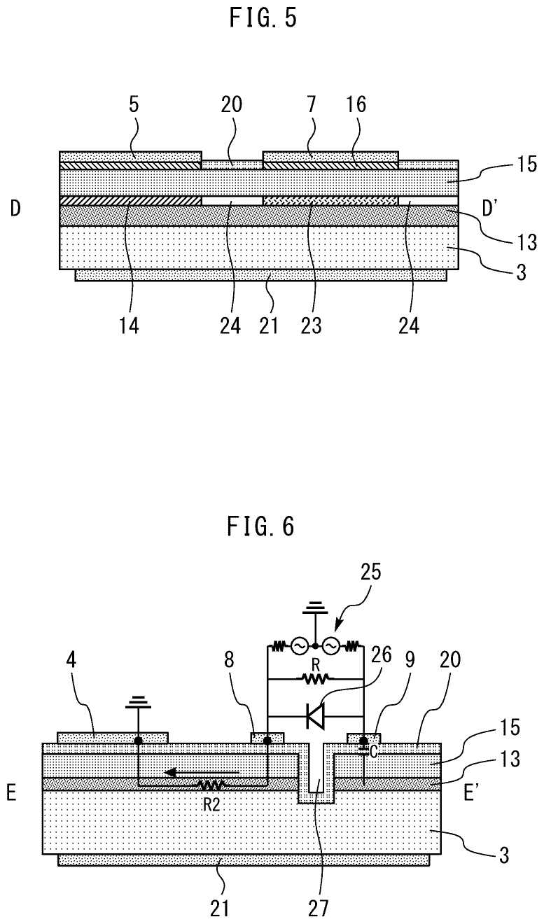

FIG. 5 is a cross-sectional view taken along D-D′ in FIG. 1. The active layer 14 and the absorbing layer 23 are connected by a transparent waveguide layer 24. The transparent waveguide layer 24 is also formed between the absorbing layer 23 and an emission end surface. The transparent waveguide layer 24 is made of an InGaAsP monolayer.

FIG. 6 is a cross-sectional view taken along E-E′ in FIG. 1. The cathode electrode 6 and the anode electrode 7 of the optical modulator 2 are each connected to a differential power supply 25. The differential power supply 25 performs a push-pull operation by alternately applying a positive voltage to one terminal and a negative voltage to the other terminal. Without limitation to this, the voltage on the anode side may be varied and the electric potential on the cathode side may be zero. A load resistance R is connected in parallel to a p-n junction 26 of the optical modulator 2. The load resistance R is provided outside the device for impedance matching.

A groove 27 is formed in the semiconductor layer 22 between the cathode pad 8 and the anode pad 9. Specifically, the groove 27 penetrates the p-InP cladding layer 15 and the n-InP cladding layer 13, and reaches the semi-insulating InP substrate 3. The groove 27 and the grooves 18, 19 may be formed simultaneously.

The n-InP cladding layer 13 usually has a very low resistance to reduce the series resistance of the optical modulator 2. Therefore, it is necessary for the groove 27 to remove at least a portion of the n-InP cladding layer 13, and preferably penetrate the n-InP cladding layer 13. If a high-concentration n-type layer is provided over the entire surface of the n-InP cladding layer 13 to connect the n-InP cladding layer 13 and the cathode electrode 6, it is also necessary for the groove 27 to split this n-type layer.

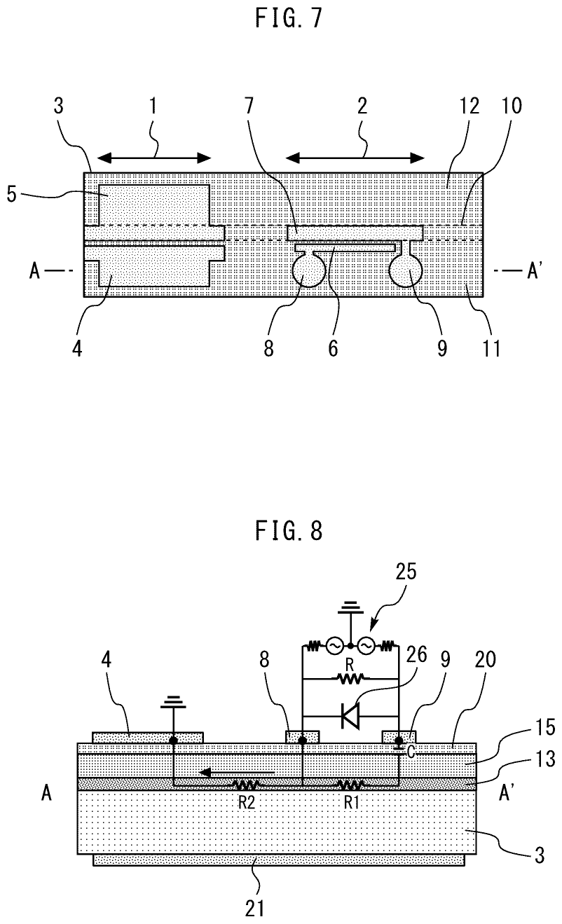

Next, the effect of the present embodiment will be described in comparison with a comparative example. FIG. 7 is a top view showing an optical semiconductor device according to the comparative example. FIG. 8 is a cross-sectional view taken along A-A′ in FIG. 7. The groove 27 is not formed in the comparative example. The cathode pad 8 and the anode pad 9 are high-frequency connected through the insulating film 20, the p-InP cladding layer 15, and the n-InP cladding layer 13. Therefore, a resistance R1 that is a leakage current path is present in the semiconductor layer 22 between the cathode pad 8 and the anode pad 9.

Moreover, the cathode pad 8 of the optical modulator 2 and the cathode electrode 4 of the laser unit 1 are also high-frequency connected through the insulating film 20, the p-InP cladding layer 15, and the n-InP cladding layer 13. Therefore, a resistance R2 that is a leakage current path is present in the semiconductor layer 22 between the anode pad 9 and the cathode electrode 4. Note that the positions of the cathode pad 8 and the anode pad 9 of the optical modulator 2 may be reversed. In this case, an electric potential difference occurs between the anode electrode 7 of the optical modulator 2 and the cathode electrode 4 of the laser unit 1, and a leakage current occurs.

A current caused by the anode voltage of the differential power supply 25 flows to each of a path passing through the load resistance R and the resistance R2, and a path passing through a capacitance C of the insulating film 20, the resistance R1 and the resistance R2. A current caused by the cathode voltage flows to the cathode electrode 4 of the laser unit 1 through the resistance R2.

The higher the frequency, the lower the impedance of the capacitance C, and the more the leakage current flows through the resistance R1. Since the current flowing through the load resistance R decreases due to the increase of the leakage current, the voltage to be applied to the optical modulator 2 decreases. Therefore, as the frequency increases, the leakage current increases, and the extinction ratio decreases, resulting in a reduction of the frequency band.

On the other hand, in the present embodiment, the groove 27 is formed in the semiconductor layer 22 between the cathode pad 8 and the anode pad 9. Since this groove 27 splits the leakage current path between the cathode pad 8 and the anode pad 9 and reduces the leakage current, the response particularly in a high frequency range is improved. As a result, a reduction of the frequency band can be prevented. Note that the same effect can also be obtained even in a semiconductor device including a single optical modulator without the laser unit 1 if the groove 27 is formed between the cathode pad 8 and the anode pad 9.

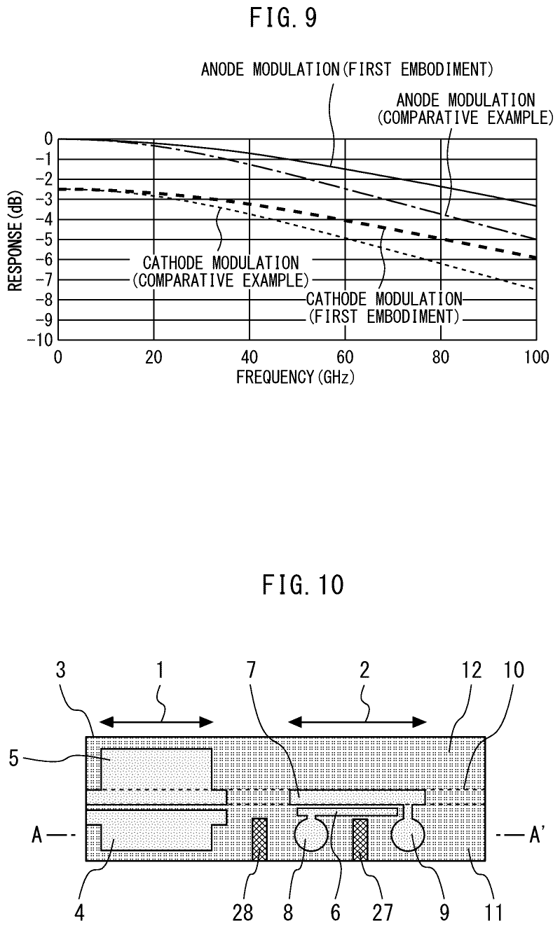

FIG. 9 is a diagram showing the frequency response characteristics of the first embodiment and the comparative example. The vertical axis of the diagram relatively indicates the frequency dependence of the optical intensity amplitude when the frequency is changed while the amplitude of pulse voltage applied to the optical modulator is kept constant. It can be understood that, in present embodiment, both the frequency dependence of the optical response to modulation of the anode voltage and the frequency dependence of the optical response to modulation of the cathode voltage are improved compared to the comparative example.

### Second Embodiment

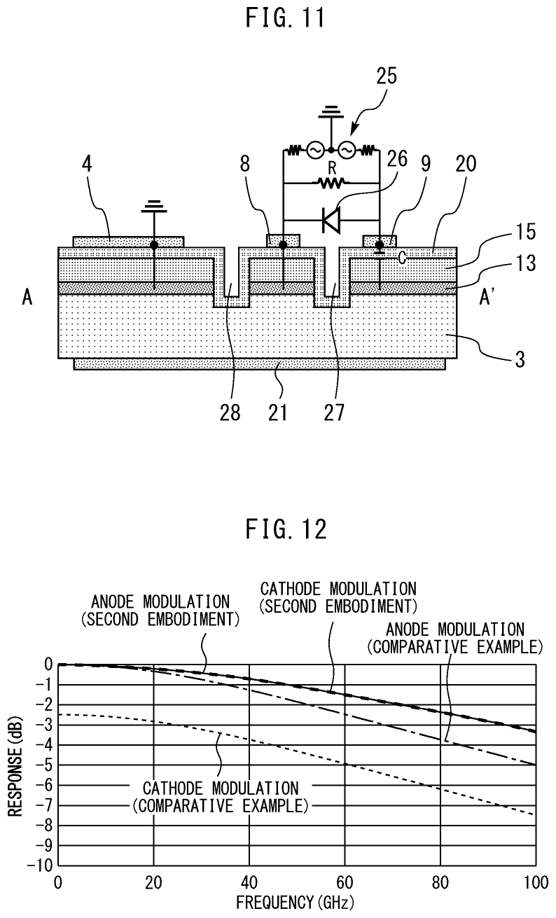

FIG. 10 is a top view showing an optical semiconductor device according to a second embodiment. FIG. 11 is a cross-sectional view taken along A-A′ in FIG. 10. Not only the groove 27 in the first embodiment, but also a groove 28 is formed between the cathode pad 8 of the optical modulator 2 and the cathode electrode 4 of the laser unit 1. The groove 28 electrically separates low-resistance layers such as the p-InP cladding layer 15 and the n-InP cladding layer 13. Consequently, since the leakage current flowing to the cathode electrode 4 of the laser unit 1 due to the cathode voltage is reduced, the amplitude of cathode modulation is increased.

Note that, when the positions of the cathode pad 8 and the anode pad 9 of the optical modulator 2 are reversed, the groove 28 is formed between the anode pad 9 of the optical modulator 2 and the cathode electrode 4 of the laser unit 1. In other words, the groove 28 is formed between the cathode electrode 4 and the cathode pad 8 or the anode pad 9 of the optical modulator 2 which is closer to the cathode electrode 4 of the laser unit 1.

FIG. 12 is a diagram showing the frequency response characteristics of the second embodiment and the comparative example. It can be understood that, in present embodiment, both the frequency response to anode modulation and the frequency response to cathode modulation are improved compared to the comparative example. Since the two grooves 27, 28 make the frequency response characteristics to the anode modulation and the cathode modulation almost the same, it is possible to perform an ideal differential operation.

Moreover, in the comparative example, since the resistances R1, R2 are present, the path of the current caused by the cathode voltage and the path of the current caused by the anode voltage are different, and the impedances of both are also different. On the other hand, in the present embodiment, since the grooves 27, 28 split the paths of current flowing through the resistances R1, R2, the current due to both voltages flows only through the load resistance R. Consequently, the impedance on the anode side and the impedance on the cathode side become equal. As a result, the amplitude and phase of noise on the anode side can match those on the cathode side, and the noise reduction effect by the differential operation can be maximized.

### Third Embodiment

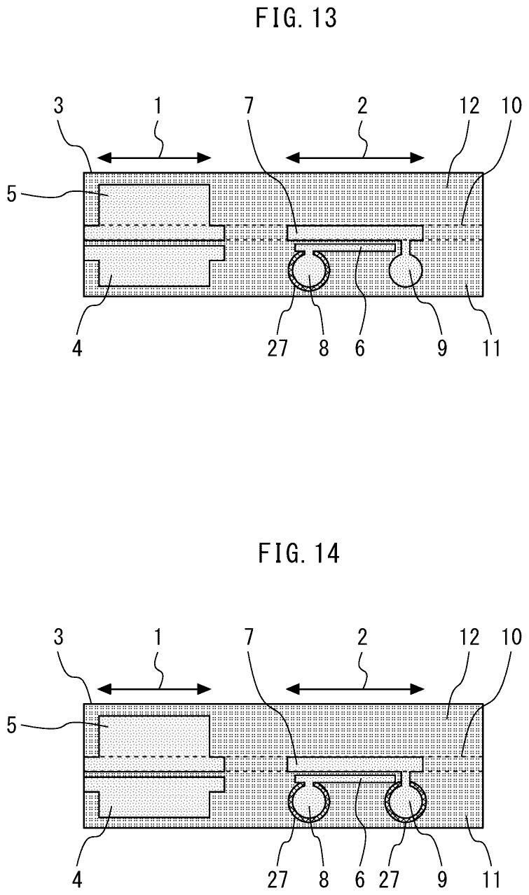

FIG. 13 is a top view showing an optical semiconductor device according to a third embodiment. The groove 27 is formed along the outer periphery of the cathode pad 8. The closer the groove 27 is to the pad, the smaller the capacitance between the pad and a back metal, and, therefore, the frequency characteristics are improved. Although the groove 27 is preferably formed in the entire region of the outer periphery of the cathode pad 8, the groove 27 may be partially formed. The groove 27 may also be formed along the outer periphery of the anode pad 9. Other components and effects are the same as those in the first embodiment.

### Fourth Embodiment

FIG. 14 is a top view showing an optical semiconductor device according to a fourth embodiment. The groove 27 is formed along the outer periphery of each of the cathode pad 8 and the anode pad 9. Although the groove 27 is preferably formed in the entire region of the outer periphery of each of the cathode pad 8 and the anode pad 9, the groove 27 may be partially formed. Other components and effects are the same as those in the first embodiment.

The area of the anode pad 9 and the area of the cathode pad 8 are preferably equal. By making the parasitic capacitance of both pads equal, the frequency response characteristics to anode modulation and the frequency response characteristics to cathode modulation become almost the same, thereby enabling an ideal differential operation. Moreover, by making the impedance on the anode side and the impedance on the cathode side equal, it is possible to match the amplitude and phase of noise on the anode side and the amplitude and phase of noise on the cathode side, and therefore the noise reduction effect by the differential operation can be maximized.

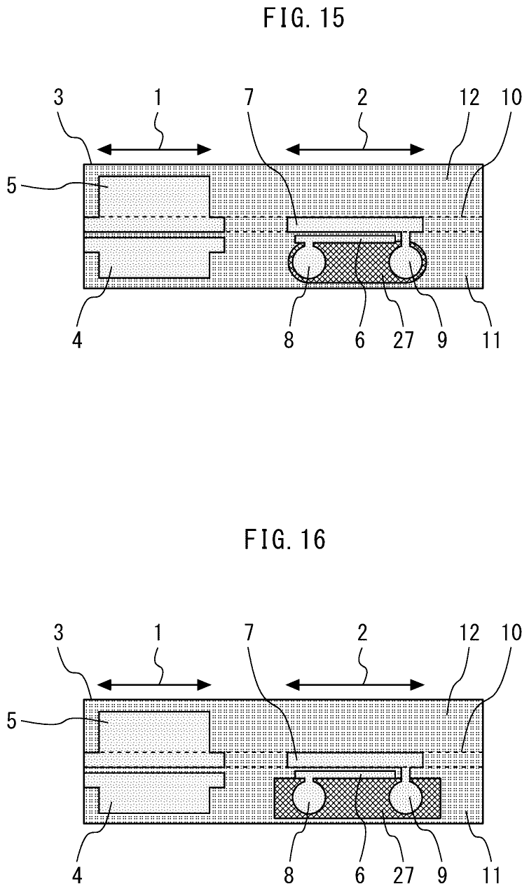

FIG. 15 is a top view showing an optical semiconductor device of a first modified example according to the fourth embodiment. The groove 27 is formed not only on the outer periphery of the pads, but also in the entire region between the cathode pad 8 and the anode pad 9. FIG. 16 is a top view showing an optical semiconductor device of a second modified example according to the fourth embodiment. In the second modified example, the groove 27 is formed in a rectangular shape including the outer periphery of the pads and the space between the pads. Note that the insulating film 20 and the semiconductor layer 22 remain directly below the cathode pad 8 and the anode pad 9. There are no particular restrictions on the length and width of the groove 27 as long as the groove 27 can electrically isolate the pads from each other.

### Fifth Embodiment

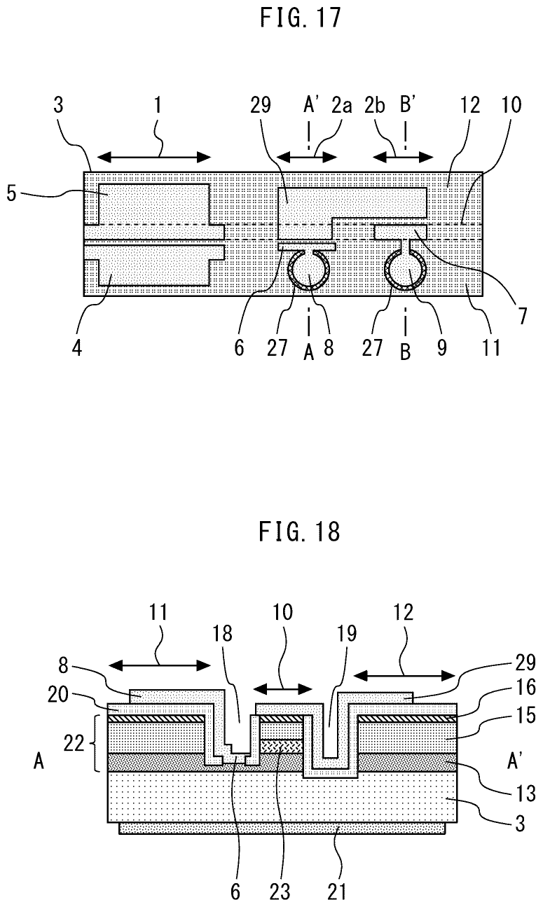

FIG. 17 is a top view showing an optical semiconductor device according to a fifth embodiment. The optical modulator 2 includes a first optical modulator 2a and a second optical modulator 2b placed in the traveling direction of light. FIG. 18 is a cross-sectional view of the first optical modulator taken along A-A′ in FIG. 17. A common electrode 29 is connected to the p-InGaAs contact layer 16 of the first optical modulator 2a. The cathode electrode 6 is connected to the n-InP cladding layer 13 of the first optical modulator 2a on the bottom surface of the groove 18.

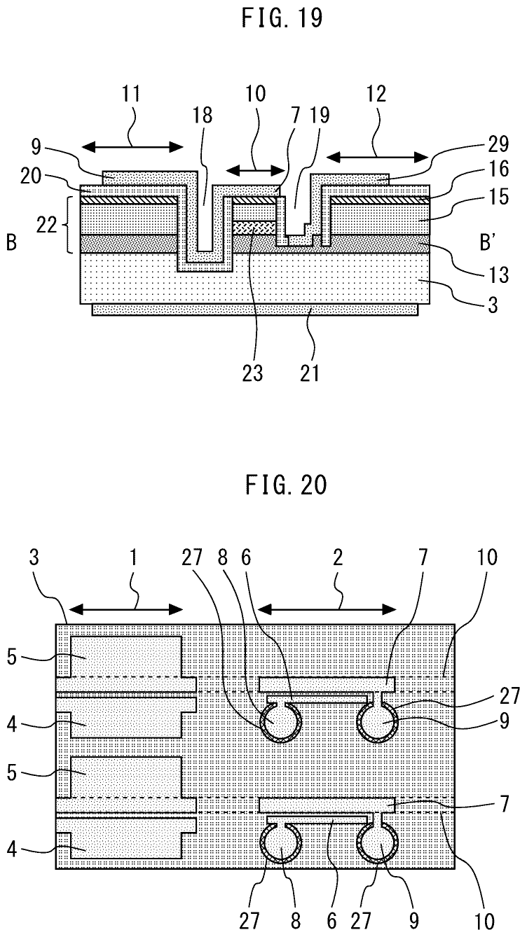

FIG. 19 is a cross-sectional view of the second optical modulator taken along B-B′ in FIG. 17. The anode electrode 7 is connected to the p-InGaAs contact layer 16 of the second optical modulator 2b. The common electrode 29 is connected to the n-InP cladding layer 13 of the second optical modulator 2b on the bottom surface of the groove 19. Therefore, the first optical modulator 2a and the second optical modulator 2b are electrically connected in series. The first optical modulator 2a and the second optical modulator 2b are differentially operated between the cathode pad 8 and the anode pad 9.

Like the fourth embodiment, the groove 27 is formed along the outer periphery of each of the cathode pad 8 and the anode pad 9. The leakage current path between the cathode pad 8 and the anode pad 9 is split by the groove 27, and the leakage current is reduced, thereby preventing a reduction of the frequency band. Other components are the same as those in the fourth embodiment.

### Sixth Embodiment

FIG. 20 is a top view showing an optical semiconductor device according to a sixth embodiment. A plurality of modulator-integrated laser diodes are integrated on one chip. The waveguides 10 of the plurality of laser diodes are positioned parallel to each other. One laser unit 1 and a plurality of optical modulators 2 connected to the laser unit 1 may be integrated on one chip. The wavelengths of emitted light from the plurality of laser diodes may be different from or equal to each other, and are set appropriately depending on an application. The groove 27 is formed along the outer periphery of each of the cathode pad 8 and the anode pad 9 of each optical modulator 2. In other words, the groove 27 is formed between the cathode pad 8 and the anode pad 9 of each of the plurality of optical modulators 2. Consequently, it is possible to reduce a leakage current flowing from one optical modulator 2 to another optical modulator 2, or the laser unit 1.

### Seventh Embodiment

FIG. 21 is a top view showing an optical semiconductor device according to a seventh embodiment. When the groove 27 is formed in the semiconductor layer 22, the chip is more likely to crack due to external stress. In particular, when stress is applied to a narrow region of the chip by a chip pick-up collet during assembly, the chip cracks more easily. Therefore, a dummy pad 30 having the same height as the cathode pad 8 and the anode pad 9 is placed on the second terrace 12 on the opposite side to the first terrace 11 on which the cathode pad 8 and the anode pad 9 are placed. The dummy pad 30 is a floating electrode that is not connected to the semiconductor layer 22 or any other electrodes. Since the pressure of the collet is dispersed by the dummy pad 30, it is possible to reduce cracking of the chip.

### Eighth Embodiment

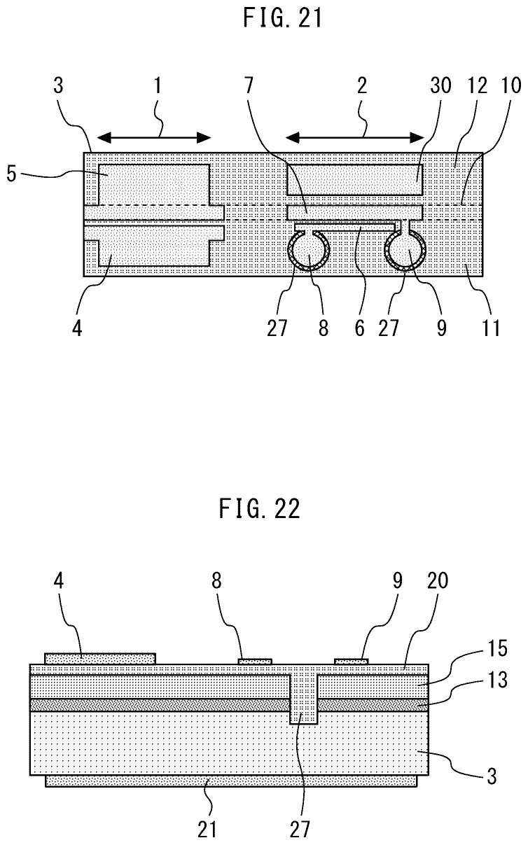

FIG. 22 is a cross-sectional view showing an optical semiconductor device according to an eighth embodiment. FIG. 22 corresponds to a cross-sectional view taken along E-E′ in FIG. 1. The groove 27 is entirely filled with the insulating film 20. Consequently, since the unevenness on the surface of the device can be reduced, a resist can be uniformly applied when forming the cathode electrode 6 and the anode electrode 7 near the groove 27. Therefore, it is possible to narrow the line widths of the cathode electrode 6 and the anode electrode 7.

### Ninth Embodiment

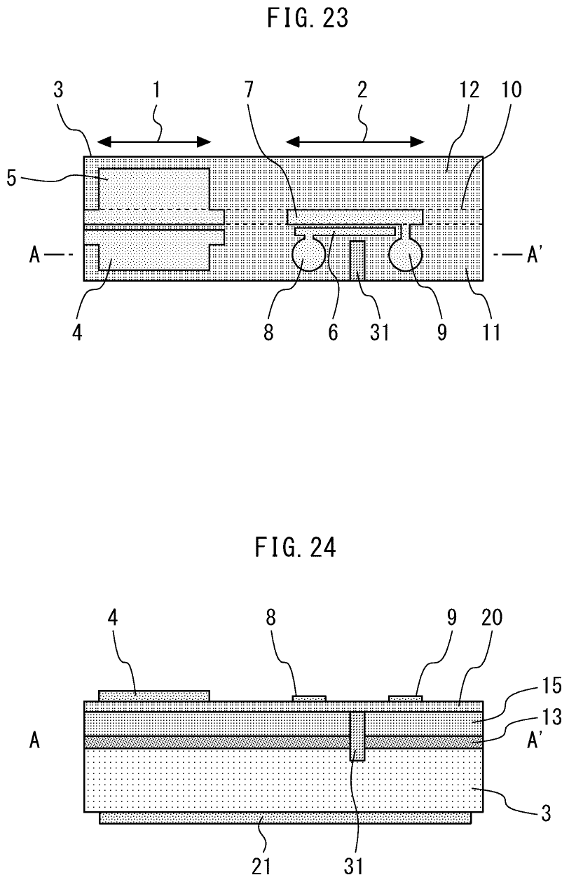

FIG. 23 is a top view showing an optical semiconductor device according to a ninth embodiment. FIG. 24 is a cross-sectional view taken along A-A′ in FIG. 23. Instead of the groove 27 in the first embodiment, a high-resistance layer 31 with increased resistance is formed between the cathode pad 8 and the anode pad 9 by implantation of protons, silicon, helium or argon ions into the p-InP cladding layer 15 and the n-InP cladding layer 13. The leakage current path between the cathode pad 8 and the anode pad 9 is split by the high-resistance layer 31, and the leakage current is reduced, thereby preventing a reduction of the frequency band. Other components are the same as those in the first embodiment. Note that the grooves 27, 28 in the second to seventh embodiments may be replaced by the high-resistance layer 31.

Although the preferred embodiments and the like have been described in detail above, the present disclosure is not limited to the above-described embodiments and the like, but the above-described embodiments and the like can be subjected to various modifications and replacements without departing from the scope described in the claims. Aspects of the present disclosure will be collectively described as supplementary notes.

### (Supplementary Note 1)

An optical semiconductor device comprising:
a substrate;
an optical modulator including a semiconductor layer having a first conductive type layer, an absorbing layer and a second conductive type layer which are formed in this order on the substrate, a first electrode connected to the first conductive type layer, and a second electrode connected to the second conductive type layer;
a first pad connected to the first electrode; and
a second pad connected to the second electrode,
wherein the semiconductor layer includes a waveguide, a first terrace and a second terrace positioned on the opposite sides with respect to the waveguide,
the first pad and the second pad are placed on the first terrace via an insulating film, and
a groove is formed in the semiconductor layer between the first pad and the second pad.

### (Supplementary Note 2)

The optical semiconductor device according to Supplementary Note 1, wherein the groove penetrates the first conductive type layer and the second conductive type layer.

### (Supplementary Note 3)

The optical semiconductor device according to Supplementary Note 1 or 2, further comprising a laser unit monolithically integrated with the optical modulator on the substrate,
wherein the laser unit includes an electrode placed on the first terrace, and
the groove is formed between the electrode and the first pad or the second pad which is closer to the electrode.

### (Supplementary Note 4)

The optical semiconductor device according to any one of Supplementary Notes 1 to 3, wherein the groove is formed along an outer periphery of at least one of the first pad and the second pad.

### (Supplementary Note 5)

The optical semiconductor device according to any one of Supplementary Notes 1 to 4, wherein the groove is formed in an entire region between the first pad and the second pad.

### (Supplementary Note 6)

The optical semiconductor device according to any one of Supplementary Notes 1 to 5, wherein the optical modulator includes a first optical modulator and a second optical modulator which are placed in a traveling direction of light and electrically connected in series.

### (Supplementary Note 7)

The optical semiconductor device according to any one of Supplementary Notes 1 to 5, wherein the optical modulator includes a plurality of optical modulators, and
the groove is formed between the first pad and the second pad in each of the plurality of optical modulators.

### (Supplementary Note 8)

The optical semiconductor device according to any one of Supplementary Notes 1 to 7, further comprising a dummy pad having the same height as the first pad and the second pad and placed on the second terrace.

### (Supplementary Note 9)

The optical semiconductor device according to any one of Supplementary Notes 1 to 8, wherein the groove is entirely filled with the insulating film.

### (Supplementary Note 10)

An optical semiconductor device comprising:
a substrate;
an optical modulator including a semiconductor layer having a first conductive type layer, an absorbing layer and a second conductive type layer which are formed in this order on the substrate, a first electrode connected to the first conductive type layer, and a second electrode connected to the second conductive type layer;
a first pad connected to the first electrode; and
a second pad connected to the second electrode,
wherein the semiconductor layer includes a waveguide, a first terrace and a second terrace positioned on the opposite sides with respect to the waveguide,
the first pad and the second pad are placed on the first terrace via an insulating film, and
a high-resistance layer with increased resistance is formed between the first pad and the second pad by implantation of protons, silicon, helium or argon ions into the semiconductor layer.

### REFERENCE SIGNS LIST

1 laser unit; 2 optical modulator; 2a first optical modulator; 2b second optical modulator; 3 semi-insulating InP substrate (substrate); 4 cathode electrode (electrode); 6 cathode electrode (first electrode); 7 anode electrode (second electrode); 8 cathode pad (first pad); 9 anode pad (second pad); 10 waveguide; 11 first terrace; 12 second terrace; 13 n-InP cladding layer (first conductive type layer); 15 p-InP cladding layer (second conductive type layer); 20 insulating film; 22 semiconductor layer; 23 absorbing layer; 27,28 groove; 30 dummy pad; 31 high-resistance layer

Obviously many modifications and variations of the present disclosure are possible in the light of the above teachings. It is therefore to be understood that within the scope of the appended claims the invention may be practiced otherwise than as specifically described.

The entire disclosure of Japanese Patent Application No. 2024-193716, filed on Nov. 5, 2024 including specification, claims, drawings and summary, on which the convention priority of the present application is based, is incorporated herein by reference in its entirety.

1. An optical semiconductor device comprising:
a substrate;
an optical modulator including a semiconductor layer having a first conductive type layer,
an absorbing layer and a second conductive type layer which are formed in this order on the substrate, a first electrode connected to the first conductive type layer, and a second electrode connected to the second conductive type layer;
a first pad connected to the first electrode; and
a second pad connected to the second electrode,
wherein the semiconductor layer includes a waveguide, a first terrace and a second terrace positioned on the opposite sides with respect to the waveguide,
the first pad and the second pad are placed on the first terrace via an insulating film, and
a groove is formed in the semiconductor layer between the first pad and the second pad.

2. The optical semiconductor device according to claim 1, wherein the groove penetrates the first conductive type layer and the second conductive type layer.

3. The optical semiconductor device according to claim 1, further comprising a laser unit monolithically integrated with the optical modulator on the substrate,
wherein the laser unit includes an electrode placed on the first terrace, and
the groove is formed between the electrode and the first pad or the second pad which is closer to the electrode.

4. The optical semiconductor device according to claim 1, wherein the groove is formed along an outer periphery of at least one of the first pad and the second pad.

5. The optical semiconductor device according to claim 1, wherein the groove is formed in an entire region between the first pad and the second pad.

6. The optical semiconductor device according to claim 1, wherein the optical modulator includes a first optical modulator and a second optical modulator which are placed in a traveling direction of light and electrically connected in series.

7. The optical semiconductor device according to claim 1, wherein the optical modulator includes a plurality of optical modulators, and
the groove is formed between the first pad and the second pad in each of the plurality of optical modulators.

8. The optical semiconductor device according to claim 1, further comprising a dummy pad having the same height as the first pad and the second pad and placed on the second terrace.

9. The optical semiconductor device according to claim 1, wherein the groove is entirely filled with the insulating film.

10. An optical semiconductor device comprising:
a substrate;
an optical modulator including a semiconductor layer having a first conductive type layer,
an absorbing layer and a second conductive type layer which are formed in this order on the substrate, a first electrode connected to the first conductive type layer, and a second electrode connected to the second conductive type layer;
a first pad connected to the first electrode; and
a second pad connected to the second electrode,
wherein the semiconductor layer includes a waveguide, a first terrace and a second terrace positioned on the opposite sides with respect to the waveguide,
the first pad and the second pad are placed on the first terrace via an insulating film, and
a high-resistance layer with increased resistance is formed between the first pad and the second pad by implantation of protons, silicon, helium or argon ions into the semiconductor layer.
